(19) United States
(12) Patent Application Publication
(10) Pub. No.: US 2023/0088754 A1
(43) Pub. Date: Mar. 23, 2023

(54) ACTIVE-ENERGY-RAY-CURABLE COMPOSITION, ACTIVE-ENERGY-RAY-CURABLE INK COMPOSITION, ACTIVE-ENERGY-RAY-CURABLE INKJET INK COMPOSITION, COMPOSITION STORED CONTAINER, AND TWO-DIMENSIONAL OR THREE-DIMENSIONAL IMAGE FORMING APPARATUS

(71) Applicants: Hikaru ISHII, Kanagawa (JP); Stoshi Kojima, Kanagawa (JP); Yuusuke Fujita, Tokyo (JP); Tatsuki Yamaguchi, Kanagawa (JP); Hiroki Kobayashi, Kanagawa (JP); Shunsuke Kobayashi, Kanagawa (JP)

(72) Inventors: Hikaru ISHII, Kanagawa (JP); Stoshi Kojima, Kanagawa (JP); Yuusuke Fujita, Tokyo (JP); Tatsuki Yamaguchi, Kanagawa (JP); Hiroki Kobayashi, Kanagawa (JP); Shunsuke Kobayashi, Kanagawa (JP)

(73) Assignee: Ricoh Company, Ltd., Tokyo (JP)

(21) Appl. No.: 17/929,765

(22) Filed: Sep. 6, 2022

(30) Foreign Application Priority Data
Sep. 16, 2021 (JP) 2021-151467
May 20, 2022 (JP) 2022-083281

(51) Int. Cl. C09D 11/107; C08F 220/34

(52) U.S. Cl. CPC C09D 11/107; C08F 220/343

(57) ABSTRACT

An active-energy-ray-curable composition includes: an adduct of trifunctional urethane acrylate; and a heterocyclic monofunctional monomer. A proportion of the heterocyclic monofunctional monomer in the active-energy-ray-curable composition is 10% by mass or more but 60% by mass or less.

### CROSS-REFERENCE TO RELATED APPLICATIONS

This patent application is based on and claims priority pursuant to 35 U.S.C. § 119(a) to Japanese Patent Application No. 2021-151467, filed on Sep. 16, 2021 and Japanese Patent Application No. 2022-083281, filed on May 20, 2022, in the Japan Patent Office, the entire disclosure of each of which is hereby incorporated by reference herein.

### BACKGROUND

### Technical Field

The present disclosure relates to an active-energy-ray-curable composition, an active-energy-ray-curable ink composition, an active-energy-ray-curable inkjet ink composition, a composition stored container, and a two-dimensional or three-dimensional image forming apparatus.

### Description of the Related Art

Cured by irradiation of active energy rays, active-energy-ray-curable compositions have more excellent drying property than solvent ink compositions and are required to have adhesiveness to plastic base materials such as acrylic materials.

### SUMMARY

According to an embodiment of the present disclosure, an active-energy-ray-curable composition includes: an adduct of trifunctional urethane acrylate; and a heterocyclic monofunctional monomer. A proportion of the heterocyclic monofunctional monomer in the active-energy-ray-curable composition is 10% by mass or more but 60% by mass or less.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating one example of a two-dimensional or three-dimensional image forming apparatus according to the present disclosure;

FIG. 2 is a schematic diagram illustrating another example of the two-dimensional or three-dimensional image forming apparatus according to the present disclosure;

FIG. 3A is a schematic diagram illustrating another example of the two-dimensional or three-dimensional image forming apparatus according to the present disclosure;

FIG. 3B is a schematic diagram illustrating another example of the two-dimensional or three-dimensional image forming apparatus according to the present disclosure;

FIG. 3C is a schematic diagram illustrating another example of the two-dimensional or three-dimensional image forming apparatus according to the present disclosure; and

FIG. 3D is a schematic diagram illustrating another example of the two-dimensional or three-dimensional image forming apparatus according to the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

According to the present disclosure, it is possible to provide an active-energy-ray-curable composition that can achieve excellent adhesiveness and blocking resistance.

### (Active-Energy-Ray-Curable Composition)

An active-energy-ray-curable composition of the present disclosure includes an adduct of trifunctional urethane acrylate and a heterocyclic monofunctional monomer, preferably includes a polymerizable compound, a polymerization initiator, a polymerization promotor, a colorant, and an organic solvent, and further includes other components according to the necessity.

A related art had a problem that achievement of adhesiveness to a base material decreases strength and blocking resistance of a coating film.

On the other hand, the related art had a problem that addition of a crosslinking component for improving blocking resistance increases internal stress of a coating film to decrease adhesiveness to a base material.

The active-energy-ray-curable composition of the present disclosure is based on the findings that conventional active-energy-ray-curable compositions may have a decreased blocking resistance when its coating film is softened in order to increase adhesiveness to a base material, and may have a decreased adhesiveness to the base material when a crosslinking component such as a polyfunctional monomer is added in order to improve blocking resistance.

### <Adduct of Trifunctional Urethane Acrylate>

The structure of trifunctional urethane acrylate is an adduct that includes crosslinking points composed of C—C bonds having a small steric hindrance. Because the adduct forms a crosslinked structure through a chemical bond between high molecules to become more rigid molecule than isocyanates or biurets, an ink cured product that achieves flexibility that affects adhesiveness to a base material and blocking resistance can be obtained.

A molecular weight of the trifunctional urethane acrylate is preferably 1,000 or more but 9,000 or less, and more preferably 1,000 or more but 4,000 or less.

The trifunctional urethane acrylate can be identified as the adduct through, for example, liquid chromatography/mass spectrometry or gas chromatography/mass spectrometry.

A proportion of the adduct of trifunctional urethane acrylate is not particularly limited and may be appropriately selected depending on the intended purpose, but is preferably 1% by mass or more but 5% by mass or less relative to the total amount of the active-energy-ray-curable composition. When the proportion is 1% by mass or more, excellent blocking resistance can be obtained. When the proportion is 5% by mass or less, continuous discharge stability can be obtained.

### <Heterocyclic Monofunctional Monomer>

The heterocyclic monofunctional monomer includes an unsaturated bond derived from a (meth)acryloyl group as a functional group. Inclusion of the heterocyclic monofunctional monomer allows the active-energy-ray-curable composition to dissolve a base material, to thereby obtain a coating film having excellent adhesiveness to a base material.

The heterocyclic monofunctional monomer is not particularly limited and may be appropriately selected depending on the intended purpose. Examples thereof include, but are not limited to, tetrahydrofurfuryl (meth)acrylate, (meth)acryloyl morpholine, N-vinylcaprolactam, N-vinylpyrrolidone, N-(meth)acryloyloxyethyl hexahydrophthalimide, and cyclic trimethylolpropane formal (meth)acrylate. These may be used alone or in combination.

A proportion of the heterocyclic monofunctional monomer is 10% by mass or more but 60% by mass or less, and more preferably 10% by mass or more but 40% by mass or less, relative to the total amount of the active-energy-ray-curable composition. When the proportion is 10% by mass or more, excellent adhesiveness to a base material can be obtained. When the proportion is 60% by mass or less, excellent blocking resistance can be obtained.

A mass ratio (A:B) between an amount A of the trifunctional urethane acrylate and an amount B of the heterocyclic monofunctional monomer is preferably from 1:2 through 1:12, and more preferably from 1:2 through 1:8. When the mass ratio (A:B) is from 1:2 through 1:12, excellent adhesiveness to a base material and excellent blocking resistance can be obtained.

### <Polymerizable Compound>

The polymerizable compound is a polymerizable compound excluding the trifunctional urethane acrylate and the heterocyclic monofunctional monomer, and is preferably a monofunctional monomer having a structure excluding a heterocycle.

The polymerizable compound is not particularly limited and may be appropriately selected depending on the intended purpose. Examples of the polymerizable compound include, but are not limited to, phenoxyethyl acrylate, isobornyl acrylate, 2-hydroxyethyl acrylate, 4-hydroxybutyl acrylate, isobutyl acrylate, t-butylacrylate, isooctyl acrylate, 2-methoxyethyl acrylate, methoxy triethylene glycol acrylate, 2-ethoxyethyl acrylate, 3-methoxybutyl acrylate, ethoxyethyl acrylate, buthoxyethyl acrylate, ethoxydiethylene glycol acrylate, methoxydixylethyl acrylate, ethyldiglycol acrylate, imide acrylate, isoamyl acrylate, ethoxylated succinate acrylate, trifluoroethyl acrylate, o-carboxypolycaprolactone monoacrylate, N-vinylformamide, cyclohexyl acrylate, benzyl acrylate, methylphenoxyethyl acrylate, 4-t-butylcyclohexyl acrylate, caprolactone-modified tetrahydrofurfuryl acrylate, tribromophenyl acrylate, ethoxylated tribromophenyl acrylate, 2-phenoxyethyl acrylate, phenoxydiethylene glycol acrylate, 2-hydroxy-3-phenoxypropyl acrylate, 1,4-cyclohexane dimethanol monoacrylate, 2-(2-ethoxyethoxy)ethylacrylate, stearyl acrylate, diethylene glycol monobutyl ether acrylate, lauryl acrylate, isodecyl acrylate, 3,3,5-trimethylcyclohexyl acrylate, isooctyl acrylate, octyl/decyl acrylate, tridecyl acrylate, caprolactone acrylate, ethoxylated (4) nonylphenol acrylate, methoxypolyethylene glycol (350) monoacrylate, and methoxypolyethylene glycol (550) monoacrylate. These may be used alone or in combination.

### <Polymerization Initiator>

The polymerization initiator is not particularly limited as long as it can produce active species such as radicals or cations by application of energy such as active energy rays to initiate polymerization of a polymerizable compound (e.g., monomer or oligomer).

The polymerization initiator is not particularly limited and may be appropriately selected depending on the intended purpose. Examples of the polymerization initiator include, but are not limited to, radical polymerization initiators, cation polymerization initiators, and base generating agents. These may be used alone or in combination. Among them, radical polymerization initiators are preferable.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds.

A proportion of the polymerization initiator is not particularly limited and may be appropriately selected depending on the intended purpose. The proportion is preferably 5% by mass or more but 20% by mass or less relative to the total amount of the active-energy-ray-curable composition to obtain a sufficient curing speed.

### <Polymerization Promotor>

The polymerization promotor (hereinafter, may be referred to as a sensitizer) is not particularly limited and may be appropriately selected depending on the intended purpose. Examples of the polymerization promotor include, but are not limited to, amine compounds such as trimethylamine, methyl dimethanol amine, triethanol amine, p-diethylamino acetophenone, p-dimethyl amino ethylbenzoate, p-dimethyl amino benzoate-2-ethylhexyl, N,N-dimethyl benzylamine, and 4,4′-bis(diethylamino)benzophenone.

An amount of the polymerization promotor is not particularly limited and may be appropriately selected depending on the polymerization initiator to be used or its amount.

### <Colorant>

As the colorant, it is possible to use various pigments and dyes that impart black, white, magenta, cyan, yellow, green, and orange, and gloss colors such as gold and silver, depending on the intended purpose and required characteristics of the composition of the present disclosure.

The pigment is not particularly limited and may be appropriately selected depending on the intended purpose. Examples of the pigment include, but are not limited to, inorganic pigments and organic pigments. These may be used alone or in combination.

The active-energy-ray-curable composition of the present disclosure does not contain a colorant and may be colorless and transparent. In such a case, for example, such a colorless and transparent material can be suitably used as an overcoating layer to protect an image.

The inorganic pigment is not particularly limited and may be appropriately selected depending on the intended purpose. Examples of the inorganic pigment include, but are not limited to, carbon blacks (C.I. Pigment Black 7) such as furnace black, lamp black, acetylene black, and channel black, iron oxides, and titanium oxides.

The organic pigment is not particularly limited and may be appropriately selected depending on the intended purpose. Examples of the organic pigment include, but are not limited to, azo pigments such as insoluble azo pigments, condensed azo pigments, azo lakes, and chelate azo pigments, polycyclic pigments such as phthalocyanine pigments, perylene pigments, perinone pigments, anthraquinone pigments, quinacridone pigments, dioxane pigments, thioindigo pigments, isoindolinone pigments, and quinofuranone pigments, dye chelates such as basic dye chelates and acid dye chelates, dye lakes such as basic dye lakes and acid dye lakes, nitro pigments, nitroso pigments, aniline black, and daylight fluorescent pigments.

In order to increase the dispersibility of the pigment, a dispersant may be further included. The dispersant is not particularly limited and may be appropriately selected depending on the intended purpose. Examples of the dispersant include, but are not limited to, dispersants such as polymer dispersants, which are conventionally used to prepare pigment dispersion materials.

The dye is not particularly limited and may be appropriately selected depending on the intended purpose. Examples of the dye include, but are not limited to, acidic dyes, direct dyes, reactive dyes, and basic dyes. These may be used alone or in combination.

An amount of the colorant is not particularly limited and may be appropriately selected depending on the intended purpose as long as the color density to be required and the dispersibility in the composition are taken into consideration. The amount is preferably 0.1% by mass or more but 20% by mass or less of the total amount of the active-energy-ray-curable composition.

### <Organic Solvent>

The active-energy-ray-curable composition of the present disclosure may include an organic solvent, but preferably does not include an organic solvent if possible. The active-energy-ray-curable composition free of a volatile organic compound (VOC) can increase safety at the place where the composition is used and can prevent environmental pollution.

The organic solvent is not particularly limited and may be appropriately selected depending on the intended purpose. Examples of the organic solvent include, but are not limited to, conventional non-reactive organic solvents such as ether, ketone, xylene, ethyl acetate, cyclohexanone, and toluene.

The term “free of” an organic solvent means that an organic solvent is not substantially contained. The content thereof is preferably less than 0.1% by mass.

### <Other Components>

The other components are not particularly limited and may be appropriately selected depending on the intended purpose. Examples of the other components include, but are not limited to, known components such as surfactants, polymerization inhibitors, leveling agents, defoaming agents, fluorescent brighteners, permeation enhancing agents, wetting agents (humectants), fixing agents, viscosity stabilizers, fungicides, preservatives, antioxidants, ultraviolet absorbents, chelate agents, pH adjusters (regulators), and thickeners.

### <Preparation of Active-Energy-Ray-Curable Composition>

The active-energy-ray-curable composition can be prepared by using the components described above. The preparation devices and conditions are not particularly limited and may be appropriately selected depending on the intended purpose. For example, the active-energy-ray-curable composition can be prepared by subjecting a polymerizable monomer, a pigment, a dispersant, etc., to a dispersion treatment using a dispersing machine such as a ball mill, a kitty mill, a disk mill, a pin mill, and a DYNO-MILL to prepare a pigment liquid dispersion, and further mixing the obtained pigment liquid dispersion with a polymerizable monomer, an initiator, a polymerization inhibitor, and a surfactant.

### <Viscosity>

The viscosity of the active-energy-ray-curable composition is not particularly limited as long as it is appropriately adjusted depending on uses and application units, and may be appropriately selected depending on the intended purpose. For example, a discharging unit configured to discharge the active-energy-ray-curable composition from nozzles is used, the viscosity at 25° C. is preferably 3 mPa·s or more but 40 mPa·s or less, more preferably 5 mPa·s or more but 15 mPa·s or less, and particularly preferably 6 mPa·s or more but 12 mPa·s or less. The viscosity range is preferably satisfied without including the organic solvent in the active-energy-ray-curable composition.

A method for measuring the viscosity is not particularly limited and may be appropriately selected depending on the intended purpose. For example, the viscosity can be measured with a cone plate rotary viscometer (VISCOMETER TVE-22L, available from TOKI SANGYO CO., LTD.) using a cone rotor (1°34′×R24) at the number of revolutions of 50 rpm with the temperature of thermostatic circulating water being appropriately set within the range of from 20° C. through 65° C. The temperature of the circulating water can be adjusted using VISCOMATE VM-150III.

### <Application Field>

The application field of the active-energy-ray-curable composition of the present disclosure is not particularly limited. It can be applied to any field where active-energy-ray-curable compositions are used. For example, the curable composition is selected to a particular application and used for a resin for processing, a paint, an adhesive, an insulant, a releasing agent, a coating material, a sealing material, various resists, and various optical materials.

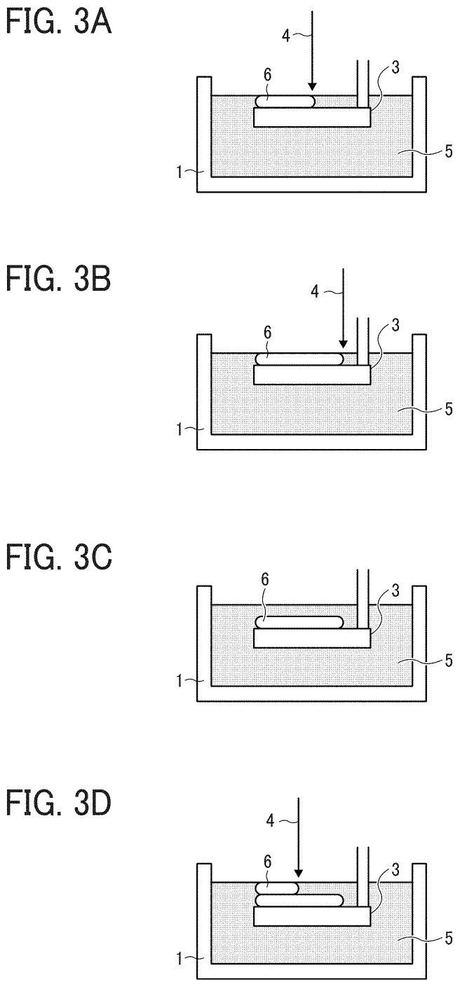

Furthermore, the active-energy-ray-curable composition of the present disclosure can be used as an ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2, FIG. 3A, FIG. 3B, FIG. 3C, and FIG. 3D.

FIG. 2 is a diagram illustrating a method of additive manufacturing to sequentially form layers of the active-energy-ray-curable composition of the present disclosure one on top of the other by repeating discharging the curable composition to particular areas followed by curing upon irradiation of an active energy ray (details will be described hereinafter). FIGS. 3A to 3D are each a diagram illustrating a method of additive manufacturing to sequentially form cured layers 6 having respective predetermined forms one on top of the other on a movable stage 3 by irradiating a storing pool (storing part) 1 of the active energy ray curable composition 5 of the present disclosure with the active energy ray 4.

In FIG. 3A, the storing pool (storing part) 1 of the active-energy-ray-curable composition 5 of the present disclosure is irradiated with the active energy rays 4. In FIG. 3B, the cured layer 6 having a predetermined shape is formed on the movable stage 3 by irradiation of the active energy rays 4. In FIG. 3C, the movable stage 3 is lowered. In FIG. 3D, the cured layer 6 is further formed on the obtained cured layer 6 by irradiation of the active energy rays 4.

An apparatus for fabricating a three-dimensional object by the active-energy-ray-curable composition of the present disclosure is not particularly limited and may be appropriately selected depending on the intended purpose. The apparatus can be a known apparatus. For example, the apparatus includes a containing device, a supplying device, and a discharging device of the curable composition, and an active energy ray irradiator.

In addition, the present disclosure includes cured materials obtained by curing the active-energy-ray-curable composition and processed products obtained by processing structures having the cured materials on a substrate. The processed product is fabricated by, for example, heat-drawing and punching a cured material or structure having a sheet-like form or film-like form. The processed product is suitably used in application fields where the surface needs to be shaped after decoration. Examples thereof are gauges or operation panels of vehicles, office machines, electric and electronic machines, and cameras.

The substrate is not particularly limited. It can suitably be selected to a particular application. Examples thereof include paper, thread, fiber, fabrics, leather, metal, plastic, glass, wood, ceramic, or composite materials thereof. Of these, plastic substrates are preferred in terms of processability.

### <Active-Energy-Ray-Curable Ink Composition>

An active-energy-ray-curable ink composition of the present disclosure includes the active-energy-ray-curable composition, and may further include other components according to the necessity.

### <Active-Energy-Ray-Curable Inkjet Ink Composition>

An active-energy-ray-curable inkjet ink composition of the present disclosure includes the active-energy-ray-curable ink composition, and may further include other components according to the necessity.

The active-energy-ray-curable inkjet ink composition can be stored in a composition stored container as described below, and can form images with an inkjet recording device as an image forming apparatus configured to discharge the ink composition on an image support such as paper.

### <Composition Stored Container>

A composition stored container of the present disclosure is a container that stores the active-energy-ray-curable composition of the present disclosure, the active-energy-ray-curable ink composition of the present disclosure, or the active-energy-ray-curable inkjet ink composition of the present disclosure, and is suitably used in the above applications. For example, if the curable composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### <Two-Dimensional or Three-Dimensional Image Forming Apparatus>

A two-dimensional or three-dimensional image forming apparatus of the present disclosure includes the composition stored container of the present disclosure and an irradiator configured to emit active energy rays, and may include a discharging unit configured to discharge the active-energy-ray-curable composition.

The irradiator is a unit configured to irradiate, with active energy rays, the discharged active-energy-ray-curable composition, the discharged active-energy-ray-curable ink composition, or the discharged active-energy-ray-curable inkjet ink composition, to cure the active-energy-ray-curable composition, active-energy-ray-curable ink composition, or active-energy-ray-curable inkjet ink composition.

The irradiator is configured to irradiate, with active energy rays, a liquid film, which includes the active-energy-ray-curable composition, the active-energy-ray-curable ink composition, or the active-energy-ray-curable inkjet ink composition and is formed on a stage, to cure the liquid film.

The active energy rays are preferably light, and are particularly preferably ultraviolet rays having a wavelength of from 220 nm through 400 nm. Active energy rays used for curing an active-energy-ray-curable composition of the present disclosure are not particularly limited, so long as they are able to give necessary energy for allowing polymerization reaction of polymerizable components in the composition to proceed. Examples of the active energy rays include electron beams, α-rays, ρ-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

The discharging unit is not particularly limited and may be appropriately selected depending on the intended purpose. Examples of the discharging unit include, but are not limited to, a continuous jetting discharging unit and an on-demand discharging unit. Examples of the on-demand discharging unit include, but are not limited to, a piezo discharging unit, a thermal discharging unit, and an electrostatic discharging unit.

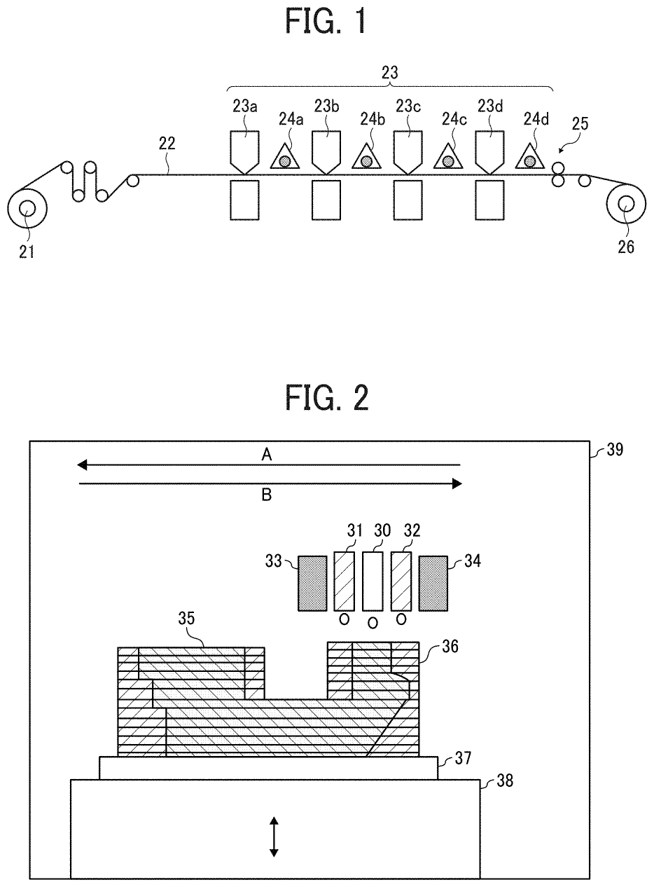

FIG. 1 is a diagram illustrating a two-dimensional image forming apparatus equipped with the discharging unit. Printing units 23a, 23b, 23c, and 23d respectively having ink cartridges and discharging heads for yellow, magenta, cyan, and black curable inks discharge the inks onto a recording medium 22 fed from a supplying roller 21. Thereafter, light sources 24a. 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing units 23a, 23b. 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods. The serial methods include discharging an ink onto a recording medium by moving the head while the recording medium intermittently moves according to the width of a discharging head. The line methods include discharging an ink onto a recording medium from a discharging head held at a fixed position while the recording medium continuously moves.

The recording medium 22 is not particularly limited. Specific examples thereof include, but are not limited to, paper, film, ceramics, glass, metal, or composite materials thereof, each of which may be in the form of a sheet. The image forming apparatus may have a one-side printing configuration and/or a two-side printing configuration. The recording medium is not limited to articles used as typical recording media. Examples of articles usable as the recording medium include cardboard, building materials (such as wall paper and floor material), concrete, cloth for apparel (such as T-shirts), textile, and leather as the recording medium.

Optionally, multiple colors can be printed with no or weak active energy ray from the light sources 24a. 24b, and 24c followed by irradiation of the active energy ray from the light source 24d. As a result, energy and cost can be saved.

The recorded matter having images printed with the ink of the present disclosure includes articles having printed images or texts on a plain surface of conventional paper, resin film, etc., a rough surface, or a surface made of various materials such as metal or ceramic. In addition, by laminating layers of images in part or the entire of a recording medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first curable composition, and ejection head units 31 and 32 for support and curing these compositions ejects a second curable composition having a different composition from the first curable composition, while ultraviolet irradiators 33 and 34 adjacent to the ejection head units 31 and 32 cure the compositions. To be more specific, for example, after the ejection head units 31 and 32 for support eject the second curable composition onto a substrate 37 for additive manufacturing and the second active-energy-ray-curable composition is solidified by irradiation of an active energy ray to form a first substrate layer having a space for composition, the ejection head unit 30 for additive manufacturing ejects the first curable composition onto the pool followed by irradiation of an active energy ray for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated 39 in FIG. 2, it can have two or more units 30.

### (Cured Product)

The cured product is formed by irradiating, with active energy rays, at least one selected from the active-energy-ray-curable composition, the active-energy-ray-curable ink composition, and the active-energy-ray-curable inkjet ink composition, followed by curing it.

An active-energy-ray-curable composition can be the same as the active-energy-ray-curable composition, an active-energy-ray-curable ink composition can be the same as the active-energy-ray-curable ink composition, and an active-energy-ray-curable inkjet ink composition can be the same as the active-energy-ray-curable inkjet ink composition.

### (Decorated Body)

The decorated body includes a base material and a surface decoration on the base material, the surface decoration being formed of the cured product as described above.

### EXAMPLES

The present disclosure will be described below by way of Examples. The present disclosure should not be construed as being limited to these Examples.

The trifunctional urethane acrylate of the present disclosure can be produced by the following methods of Synthesis Examples 1 to 3 described in JP-2002-256053-A.

### Synthesis Example 1 of Trifunctional Urethane Acrylate

A 500 mL-flask equipped with a stirrer, a thermometer, and a condenser was charged with 33 parts by mass of toluene and 4.8 parts by mass of stearyl alcohol (NAA-46), and was heated to 40° C. After stearyl alcohol was completely dissolved, 50 parts by mass of trimethylolpropane adduct-modified type of hexamethylene diisocyanate (BURNOCK DN-950; obtained from DIC Corporation, N.V.: 75. NCO %: 12) was added thereto, and the resultant was heated to 70° C. After the resultant was allowed to react at the same temperature for 30 minutes, 0.02 parts by mass of dibutyltin laurate was added thereto, and was maintained at the same temperature for 3 hours. Then, 63.9 parts by mass of polycaprolactone-modified hydroxyethyl acrylate (PLACCEL FA3; obtained from Daicel Chemical Industries. Ltd., hydroxyl value: 122), 0.02 parts by mass of dibutyltin laurate, and 0.02 parts by mass of hydroquinone monomethyl ether were added thereto, and the resultant was maintained at 70° C. for 3 hours, to complete the reaction. Then, 60.7 parts by mass of toluene was added thereto, to obtain an adduct of trifunctional urethane acrylate A having a solid content of 50% by weights.

### Synthesis Example 2 of Trifunctional Urethane Acrylate

A 500 mL-flask equipped with a stirrer, a thermometer, and a condenser was charged with 60.8 parts by mass of toluene and 8.4 parts by mass of stearyl alcohol (NAA-46, obtained from Nippon Oil & Fats Co., Ltd.), and was heated to 40° C. After stearyl alcohol was completely dissolved, 50 parts by mass of isocyanurate-modified type of hexamethylene diisocyanate (TAKENATE D-170N; obtained from Takeda Pharmaceutical Co., Ltd., NCO %: 20.9), and the resultant was heated to 70° C. After the resultant was allowed to react at the same temperature for 30 minutes, 0.02 parts by mass of dibutyltin laurate was added thereto, and was maintained at the same temperature for 3 hours. Then, 83.5 parts by mass of polycaprolactone-modified hydroxyethyl acrylate (PLACCEL FA2D; obtained from Daicel Chemical Industries, Ltd., hydroxyl value: 122), 0.02 parts by mass of dibutyltin laurate, and 0.02 parts by mass of hydroquinone monomethyl ether were added thereto, and the resultant was maintained at 70° C. for 3 hours, to complete the reaction. Then, 81.1 parts by mass of toluene was added thereto, to obtain an isocyanate of trifunctional urethane acrylate B having a solid content of 50% by weights.

### Synthesis Example 3 of Trifunctional Urethane Acrylate

A 500 mL-flask equipped with a stirrer, a thermometer, and a condenser was charged with 78.3 parts by mass of toluene and 8.5 parts by mass of stearyl alcohol (NAA-46), and was heated to 40° C. After stearyl alcohol was completely dissolved, 50 parts by mass of biuret-modified type of hexamethylene diisocyanate (DURANATE 24A-90CX; obtained from Asahi Kasei Corp., N.V.: 90, NCO %: 21.2), and the resultant was heated to 70° C. After the resultant was allowed to react at the same temperature for 30 minutes, 0.02 parts by mass of dibutyltin laurate was added thereto, and was maintained at the same temperature for 3 hours. Then, 140.8 parts by mass of polycaprolactone-modified hydroxyethyl acrylate (PLACCEL FA4; obtained from Daicel Chemical Industries, Ltd., hydroxyl value: 98), 0.02 parts by mass of dibutyltin laurate, and 0.02 parts by mass of hydroquinone monomethyl ether were added thereto, and the resultant was maintained at 70° C. for 3 hours, to complete the reaction. Then, 111 parts by mass of toluene was added thereto, to obtain a biuret of trifunctional urethane acrylate C having a solid content of 50% by weights.

### Example 1

Based on the composition (% by mass) described in Table 1, a trifunctional urethane acrylate oligomer, a heterocyclic monofunctional monomer, a polymerizable compound, a photopolymerization initiator, and a polymerization inhibitor were mixed with THREE-ONE MOTOR (obtained from Shinto Scientific Co., Ltd.), to obtain an active-energy-ray-curable composition.

### Examples 2 to 12 and Comparative Examples 1 to 6

Active-energy-ray-curable compositions were obtained in the same manner as in Example 1 except that the composition of the active-energy-ray-curable composition of Example 1 was changed to each composition described in Tables 1 to 3.

The active-energy-ray-curable compositions in Examples 1 to 12 and Comparative Examples 1 to 6 were evaluated for “blocking resistance”. “adhesiveness”, and “discharge stability”. Results are shown in Tables 1 to 3.

### <Blocking Resistance>

The blocking resistance was evaluated by using A4-sized solid coating film of each of the active-energy-ray-curable compositions in Examples 1 to 12 and Comparative Examples 1 to 6.

Specifically, each of the active-energy-ray-curable compositions in Examples 1 to 12 and Comparative Examples 1 to 6 was applied on an acrylic base material (product name: SUMIPEX, obtained from SUMITOMO CHEMICAL COMPANY, LIMITED) to form a solid coating film having a thickness of 10 μm and an area of a A4 size. The solid coating film was cured with an LED lamp (obtained from Ushio Inc.) (peak wavelength of 395 nm, 3,000 mi/cm²). The load of 5 kg per A4-size area was applied to the portion where the surface of the cured solid coating film and the acrylic base material (product name: SUMIPEX, obtained from SUMITOMO CHEMICAL COMPANY, LIMITED) had been overlaid. After left to stand at room temperature for 24 hours, the overlaid solid coating film and acrylic base material were evaluated for whether the solid coating film and the acrylic base material were attached to each other and a change in the coating film (a transfer ratio of the coating film onto the acrylic base material when the coating film was peeled from the acrylic base material), based on the following criteria.

### [Evaluation Criteria]

AA: The coating film was not attached to the acrylic base material and was not transferred onto the acrylic base material.

A: The coating film was attached to the acrylic base material and was not transferred onto the acrylic base material.

B: The coating film was attached to the acrylic base material and the transfer ratio of the coating film was less than 10%.

C: The coating film was attached to the acrylic base material and the transfer ratio of the coating film was 10% or more.

### <Adhesiveness>

The adhesiveness was examined based on the cross-cut method according to the adhesiveness test of JIS K5600-5-6, and was evaluated based on the following criteria. To examine adhesiveness, adhesiveness to a polyvinyl chloride base material (product name: GIY-11Z5, obtained from LINTEC Corporation) (PVC adhesiveness) and adhesiveness to an acrylic base material (product name: SUMIPEX, obtained from SUMITOMO CHEMICAL COMPANY, LIMITED) (Rigid adhesiveness) were evaluated. To evaluate the Rigid adhesiveness, a polycarbonate base material (product name: IUPILON, obtained from MITSUBISHI GAS CHEMICAL COMPANY, INC.) can also be used as a base material.

### [Evaluation Criteria]

AA: Cut portions were not completely peeled.

A: Peeling was found along the portions cut with a cutter, but squares were not peeled.

B: Less than fifty percent of the whole squares was peeled.

C: Fifty percent or more of the whole squares was peeled.

### <Discharge Stability>

Each of the active-energy-ray-curable compositions in Examples 1 to 12 and Comparative Examples 1 to 6 was loaded into an inkjet discharging apparatus (obtained from RICOH Company, Ltd., head: GEN5 obtained from Ricoh Printing Systems. Ltd.), and was continuously discharged for 30 minutes under the following conditions: frequency of 2 kHz and voltage of from 10 V through 20 V so that the weight of a liquid droplet was from 6 pL through 9 pL and the discharging speed was 7.0 m/s. Immediately after that, a camera (product name: ARTCAM-036MI, obtained from ARTRAY CO., LTD.) was used to count the number of nozzles that failed to discharge the composition relative to all nozzles, to evaluate discharge stability based on the following criteria.

### [Evaluation Criteria]

A: The composition was discharged from all nozzles.

B: The composition was not discharged from less than 30 nozzles.

C: The composition was not discharged from 30 or more nozzles.

TABLE 1

| | | Examples | | | | | |
|---|---|---|---|---|---|---|---|
| | | 1 | 2 | 3 | 4 | 5 | 6 |
| Trifunctional urethane | Adduct of trifunctional urethane acrylate A | 1.0 | 5.0 | 3.0 | 5.0 | 6.0 | 0.9 |
| acrylate | Isocyanate of trifunctional urethane acrylate B | — | — | — | — | — | — |
| | Biuret of trifunctional urethane acrylate C | — | — | — | — | — | — |
| Heterocyclic monofunctional | Cyclic trimethylolpropane formal acrylate | 2.0 | 2.0 | — | 20.0 | 20.0 | 20.0 |
| monomer | Tetrahydrofurfuryl acrylate | 8.0 | 8.0 | — | 40.0 | 40.0 | 40.0 |
| | Acryloyl morpholine | — | — | 36.0 | — | — | — |
| Polymerizable compound | Phenoxyethyl acrylate | 19.0 | 25.0 | — | — | — | — |
| | Benzyl acrylate | — | 24.9 | — | — | — | — |
| | 3,3,5-Trimethylcyclohexyl acrylate | 29.9 | 25.0 | 20.0 | 10.0 | 9.0 | 9.0 |
| | 4-t-butylcyclohexyl acrylate | 30.0 | — | 16.0 | 14.9 | 14.9 | 20.0 |
| | Isobornyl acrylate | — | — | 14.9 | — | — | — |
| Polymerization initiator | Omnirad TPO | 10.0 | 10.0 | 10.0 | 10.0 | 10.0 | 10.0 |
| Polymerization inhibitor | METHOQUINONE | 0.1 | 0.1 | 0.1 | 0.1 | 0.1 | 0.1 |
| Total amount | | 100.0 | 100.0 | 100.0 | 100.0 | 100.0 | 100.0 |
| Evaluation results | Blocking resistance | A | A | A | B | A | B |
| | Rigid adhesiveness | A | A | A | A | A | A |
| | PVC adhesiveness | A | A | A | A | A | A |
| | Discharge stability | A | A | A | A | B | A |

TABLE 2

| | | Examples | | | | | |
|---|---|---|---|---|---|---|---|
| | | 7 | 8 | 9 | 10 | 11 | 12 |
| Trifunctional urethane | Adduct of trifunctional urethane acrylate A | 6.0 | 0.9 | 5.0 | 1.0 | 5.0 | 1.0 |
| acrylate | Isocyanate of trifunctional urethane acrylate B | — | — | — | — | — | — |
| | Biuret of trifunctional urethane acrylate C | — | — | — | — | — | — |
| Heterocyclic monofunctional | Cyclic trimethylolpropane formal acrylate | 2.0 | 2.0 | 40.0 | 40.0 | — | — |
| monomer | Tetrahydrofurfuryl acrylate | 8.0 | 8.0 | — | 40.0 | — | 40.0 |
| | Acryloyl morpholine | — | — | — | — | — | — |
| | Phenoxyethyl acrylate | 24.0 | 19.1 | 15.0 | 19.0 | 15.0 | 19.0 |
| | Benzyl acrylate | 24.9 | — | 14.9 | 14.9 | — | — |
| Polymerizable compound | 3,3,5-Trimethylcyclohexyl acrylate | 25.0 | 29.9 | 15.0 | 14.9 | 15.0 | 14.9 |
| | 4 -t-butylcyclohexyl acrylate | — | 30.0 | — | 15.0 | — | 15.0 |
| | Isobornyl acrylate | — | — | — | — | — | — |
| Polymerization initiator | Omnirad TPO | 10.0 | 10.0 | 10.0 | 10.0 | 10.0 | 10.0 |
| Polymerization inhibitor | METHOQUINONE | 0.1 | 0.1 | 0.1 | 0.1 | 0.1 | 0.1 |
| Total amount | | 100.0 | 100.0 | 100.0 | 100.0 | 100.0 | 100.0 |
| | Blocking resistance | A | B | A | B | A | B |
| Evaluation results | Rigid adhesiveness | A | A | B | B | B | B |
| | PVC adhesiveness | A | A | B | B | A | A |
| | Discharge stability | B | A | A | A | A | A |

TABLE 3

| | | Comparative Examples | | | | | |
|---|---|---|---|---|---|---|---|
| | | 1 | 2 | 3 | 4 | 5 | 6 |
| Trifunctional | Adduct of trifunctional urethane acrylate A | 5.0 | — | — | — | 5.0 | 5.0 |
| urethane acrylate | Isocyanate of trifunctional urethane acrylate B | — | 5.0 | — | — | — | — |
| | Biuret of trifunctional urethane acrylate C | — | — | 5.0 | — | — | — |
| Heterocyclic | Cyclic trimethylolpropane formal acrylate | — | 20.0 | 20.0 | 20.0 | 30.0 | 2.0 |
| monofunctional monomer | Tetrahydrofurfuryl acrylate | — | 40.0 | 40.0 | 40.0 | 40.0 | 7.0 |
| | Acryloyl morpholine | — | — | — | — | — | — |
| Polymerizable compound | Phenoxyethyl acrylate | 35.0 | 10.0 | 10.0 | 10.0 | — | 25.0 |
| | Benzyl acrylate | 29.9 | — | — | — | — | 25.9 |
| | 3,3,5-Trimethylcyclohexyl acrylate | 20.0 | 14.9 | 14.9 | 19.9 | 14.9 | 25.0 |
| | 4-t-butylcyclohexyl acrylate | — | — | — | — | — | — |
| | Isobornyl acrylate | — | — | — | — | — | — |
| Polymerization initiator | Omnirad TPO | 10.0 | 10.0 | 10.0 | 10.0 | 10.0 | 10.0 |
| Polymerization inhibitor | METHOQUINONE | 0.1 | 0.1 | 0.1 | 0.1 | 0.1 | 0.1 |
| Total amount | | 100.0 | 100.6 | 100.0 | 100.0 | 100.0 | 100.0 |
| Evaluation results | Blocking resistance | A | C | C | C | B | B |
| | Rigid adhesiveness | B | B | B | C | C | B |
| | PVC adhesiveness | C | A | A | A | C | C |
| | Discharge stability | A | A | A | A | A | A |

Details of the components in Tables 1 to 3 are as follows.
Cyclic trimethylolpropane formal aldehyde (product name: CTFA, obtained from OSAKA ORGANIC CHEMICAL INDUSTRY LTD.)
Tetrahydrofurfuryl acrylate (product name: VISCOAT #150, obtained from OSAKA ORGANIC CHEMICAL INDUSTRY LTD.)
Acryloyl morpholine (product name: ACMO, obtained from KJ Chemicals Corporation)
Phenoxyethyl acrylate (product name: VISCOAT #192, obtained from OSAKA ORGANIC CHEMICAL INDUSTRY LTD.)
Benzyl acrylate (product name: VISCOAT #160, obtained from OSAKA ORGANIC CHEMICAL INDUSTRY LTD.)
3,3,5-Trimethylcyclohexyl acrylate (product name: VISCOAT #19%, obtained from OSAKA ORGANIC CHEMICAL INDUSTRY LTD.)
4-t-butylcyclohexyl acrylate (product name: TBCHA, obtained from KJ Chemicals Corporation)
Isobomyl acrylate (product name: IBXA, obtained from OSAKA ORGANIC CHEMICAL INDUSTRY LTD.)
Polymerization initiator (product name: Omnirad TPO, obtained from IGM)
Polymerization inhibitor (product name: METHOQUINONE, obtained from Seiko Chemical CO., Ltd)

Aspects of the present disclosure are, for example, as follows.

<1> An active-energy-ray-curable composition, including:

an adduct of trifunctional urethane acrylate; and

a heterocyclic monofunctional monomer,

wherein a proportion of the heterocyclic monofunctional monomer in the active-energy-ray-curable composition is 10% by mass or more but 60% by mass or less.

<2> The active-energy-ray-curable composition according to <1>,

wherein a proportion of the adduct of trifunctional urethane acrylate in the active-energy-ray-curable composition is 1% by mass or more but 5% by mass or less.

<3> The active-energy-ray-curable composition according to <1> or <2>,

wherein the heterocyclic monofunctional monomer includes at least one selected from the group consisting of tetrahydrofurfuryl (meth)acrylate, (meth)acryloyl morpholine, and cyclic trimethylolpropane formal (meth)acrylate.

<4> The active-energy-ray-curable composition according to any one of <1> to <3>,

wherein the heterocyclic monofunctional monomer includes at least one selected from the group consisting of tetrahydrofurfuryl (meth)acrylate, (meth)acryloyl morpholine, and cyclic trimethylolpropane formal (meth)acrylate.

<5> The active-energy-ray-curable composition according to any one of <1> to <4>,

wherein the heterocyclic monofunctional monomer includes (meth)acryloyl morpholine.

<6> The active-energy-ray-curable composition according to any one of <1> to <5>,

wherein a mass ratio (A:B) between an amount A of the adduct of trifunctional urethane acrylate and an amount B of the heterocyclic monofunctional monomer is from 1:2 through 1:12.

<7> An active-energy-ray-curable ink composition, including

the active-energy-ray-curable composition according to any one of <1> to <6>.

<8> An active-energy-ray-curable inkjet ink composition, including

the active-energy-ray-curable ink composition according to <7>.

<9> A composition stored container, including:

a container; and

the active-energy-ray-curable composition according to any one of <1> to <6>, the active-energy-ray-curable ink composition according to <7>, or the active-energy-ray-curable inkjet ink composition according to <8>.

<10> A two-dimensional or three-dimensional image forming apparatus, including:

the composition stored container according to <9>; and

an irradiator configured to emit active energy rays.

The active-energy-ray-curable composition according to any one of <1> to <6>, the active-energy-ray-curable ink composition according to <7>, the active-energy-ray-curable inkjet ink composition according to <8>, the composition stored container according to <9>, and two-dimensional or three-dimensional image forming apparatus according to <10> can solve the existing problems in the art and can achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An active-energy-ray-curable composition, comprising:
an adduct of trifunctional urethane acrylate; and
a heterocyclic monofunctional monomer,
wherein a proportion of the heterocyclic monofunctional monomer in the active-energy-ray-curable composition is 10% by mass or more but 60% by mass or less.

2. The active-energy-ray-curable composition according to claim 1,
wherein a proportion of the adduct of trifunctional urethane acrylate in the active-energy-ray-curable composition is 1% by mass or more but 5% by mass or less.

3. The active-energy-ray-curable composition according to claim 1,
wherein the heterocyclic monofunctional monomer includes at least one selected from the group consisting of tetrahydrofurfuryl (meth)acrylate, (meth)acryloyl morpholine, and cyclic trimethylolpropane formal (meth)acrylate.

4. The active-energy-ray-curable composition according to claim 1,
wherein a mass ratio (A:B) between an amount A of the adduct of trifunctional urethane acrylate and an amount B of the heterocyclic monofunctional monomer is from 1:2 through 1:12.

5. An active-energy-ray-curable ink composition, comprising
the active-energy-ray-curable composition according to claim 1.

6. An active-energy-ray-curable inkjet ink composition, comprising
the active-energy-ray-curable ink composition according to claim 5.

7. A composition stored container, comprising:
a container; and
the active-energy-ray-curable composition according to claim 1 stored in the container.

8. A two-dimensional or three-dimensional image forming apparatus, comprising:
the composition stored container according to claim 7; and
an irradiator configured to emit active energy rays.
